(19) United States
(12) Patent Application Publication
(10) Pub. No.: US 2020/0012771 A1
(43) Pub. Date: Jan. 9, 2020

(54) Method of using sequence of biometric identities, gestures, voice input, characters, symbols and pictures, as a part of credentials for user authentication, and as a part of challenge for user verification

(71) Applicants: DHAVALKUMAR SHAH, OLD BRIDGE, NJ (US); NEHAL MEHTA, OLD BRIDGE, NJ (US)

(72) Inventors: DHAVALKUMAR SHAH, OLD BRIDGE, NJ (US); NEHAL MEHTA, OLD BRIDGE, NJ (US)

(73) Assignees: DHAVALKUMAR SHAH, OLD BRIDGE, NJ (US); NEHAL MEHTA, OLD BRIDGE, NJ (US)

(21) Appl. No.: 16/030,386

(22) Filed: Jul. 9, 2018

(51) Int. Cl. G06F 21/32; G06F 21/36

(52) U.S. Cl. CPC G06F 21/32; G06K 9/00892; G06F 21/36

(57) ABSTRACT

We propose a method that uses sequence of biometric identities, gestures, voice input, characters, symbols and pictures, for user authentication and verifications. So user credential would be combination of “What he/she is and what he/she knows”.

Examples of biometric identities are finger prints, toe prints, knee scan, iris scan, palm vein and any other body parts' image or scan that uniquely identifies a person.

User may use gestures of same or different types as part of the credential.

Examples of characters are alphabets in any language, numbers and special characters like @, #, $, ˜, ! and any other available for input.

Examples of Symbols and Picture are emoticons, emoji's, image, photo or drawing.

Characters can be plain or formatted using formatting options of color, shading, font styles—bold, italic, underline, strikeout, superscript, subscript, font name, font size and other available formatting options.

Symbols and picture can be used as it is or may be formatted using picture formatting options like coloring, rotating, tinting, cropping, pinching and other available picture formatting options.

User can create credential sequence using either same biometric identity or combination of two or more different biometric identity types, plain characters, formatted characters, unformatted symbol, formatted symbol, unformatted picture and formatted picture where any of these credential sub-member may or may not be present in the sequence created as user credential.

User may use input devices including keyboard, mouse, voice input or gestures to input and optionally format characters, symbols and pictures.

Biometric input Devices, Sensors and Cameras would capture user biometric identities. Sensors and Cameras would capture user gestures.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

The proposed invention concerns security, in particular, proposed method is to provide/improve/strengthen security for individual's any kind of data, information, credit, finances, services obtained (online and or offline), authenticate application user using sequence of his/her biometric identities, gestures, voice input, characters, symbols and pictures—What he/she is and What he/she knows.

Users are required to positively authenticate for gaining physical access to various places including Offices, Homes, Restricted Area, Schools, Private Property, Government Property and any area where user has to prove that he has rights to enter. User are also required to positively authenticate themselves to unlock smartphone, unlock computers, access software applications, access websites, approve transactions, approve payments, prove as beneficiary of programs, schemes and so on.

Advent of biometrics gave hope that identity cannot be stolen. But instances of finger print reproduced on special type of paper and used to unlock accounts instead of real finger print rang alarms. There is another danger. If person is unconscious or without his/her knowledge puts finger on finger print scanner, account would be unlocked. Same way palm vein and other biometric authentication means can be used to identify person but if person is unaware whether unconscious or unknowingly provides biometric identity his/her account would be compromised. Person can be tricked in many ways to provide their biometrics. This is wrong and there should be some solution for it.

### BRIEF SUMMARY OF THE INVENTION

We propose a method that fortifies biometric based user authentication and biometric based user verification with user known sequence of biometric and other identities.

As per our method, user provides sequence of one or more biometric and other identities for user authentication and verifications. Examples of biometric identities are finger prints, toe prints, knee scan, iris scan, palm vein and any other body feature or parts' that uniquely identifies a person. He may use gestures, voice input, characters, symbols and pictures to further strengthen the credential.

Our method allows user to create sequence of biometric identities, characters, symbols and pictures, for user authentication, e-signature and verifications. So user credential would be combination of “What he/she is and what he/she knows”.

Examples of biometric identities are finger prints, toe prints, knee scan, iris scan, palm vein and any other body parts' image or scan that uniquely identifies a person.

User may use gestures of same or different types as part of the credential.

Examples of characters are alphabets in any language, numbers and special characters like @, #, $, ˜, ! and any other available for input.

Examples of Symbols and Picture can be any emoticons, emoji's, image, photo or drawing.

Characters can be plain or formatted using formatting options of color, shading, font styles—bold, italic, underline, strikeout, superscript, subscript, font name, font size and other available formatting options.

Symbols and picture can be used as it is or may be formatted using picture formatting options like coloring, rotating, tinting, cropping, pinching and other available picture formatting options.

User can create credential sequence using either same biometric identity or combination of two or more different biometric identity types, plain characters, formatted characters, unformatted symbol, formatted symbol, unformatted picture and formatted picture where any of these credential sub-member may or may not be present in the sequence created as user credential.

User may use input devices including keyboard, mouse, voice input or gestures to input and optionally format characters, symbols and pictures.

Biometric Input Devices, Sensors and Cameras would capture user biometric identities. Sensors and Cameras would capture user gestures.

We will call our method “Biopasscode” for easy reference in text below.

Examples of our method:
a) John wants to enroll in BioPasscode authentication. He provides finger print of fingers in following sequence. LH2RH2RH4LH1 where LH2—Left hand's second finger, RH2—Right hand's second finger, RH4—Right hand's 4^{th} finger, LH1—Left hand's first finger. This becomes his unique biometric passcode.
b) Henry wants to enroll in BioPasscode authentication. He provides finger and toe prints in following sequence. LH2RH2RF1LF5 where LH2—Left hand's second finger, RH2—Right hand's second finger, RF1—Right feet's 1st finger, LF5—Left feet's fifth finger. This becomes his unique biometric passcode.
c) Jolly wants to enroll in BioPasscode authentication. He provides biometric identities in following sequence, LH2RH2RPLP where LH2—Left hand's second finger, RH2—Right hand's second finger, RP—Right Palm scan, LP—Left Palm Scan. This becomes his unique biometric passcode.
d) Tom wants to enroll in BioPasscode authentication. He provides biometric identities in following sequence. LKRH2RPRK where LK—Left knee scan, RH2—Right hand's second finger, RP—Right Palm scan, RK—Right Knee Scan, This becomes his unique biometric passcode.
e) Heli wants to enroll in BioPasscode authentication. She creates credential sequence as: LH2 X <P1y>
where LH2—Left hand's second finger, X—Alphabet char and <P1>—Picture tinted in yellow color. This becomes her unique biometric passcode.
f) Molly wants to enroll in BioPasscode authentication. She creates credential sequence as: R<E1> <P1>RH3
where R—Alphabet char in Bold Style, <E1>—Emoticon, <P1>—Picture and RH3—Right hand's third finger. This becomes her unique biometric passcode.
g) Trisha wants to enroll in BioPasscode authentication. She creates credential sequence as: <E2>RH1LH2 [symbol]
where <E2>—Emoticon, RH1—Right hand's first finger, LH2—Left hand's second finger and 9—Number in Italic style, Red font color and grey background. This becomes her unique biometric passcode.
h) Sara wants to enroll in BioPasscode authentication. She creates credential sequence as: RH2LH2 [symbol]
where RH2—Right hand's second finger, LH2—Left hand's second finger and ‘Code’ is underlined alphabets, 2—Number which is strike out with white font color and black background (shading). ‘Code’ is in yellow font color and black background color (shading). # is in black font and grey background (shading). This becomes her unique biometric passcode.
i) Sneha wants to enroll in BioPasscode authentication. She creates credential sequence as: RH1G1V1
where RH1—Right hand's first finger, G1—Gesture 1 out of one of more gestures defined by user, V1—Voice input 1 out of one or more voice input defined by user. This becomes her unique biometric passcode.

### BRIEF DESCRIPTION OF THE SEVERAL VIEWS OF THE DRAWING

### Flowcharts

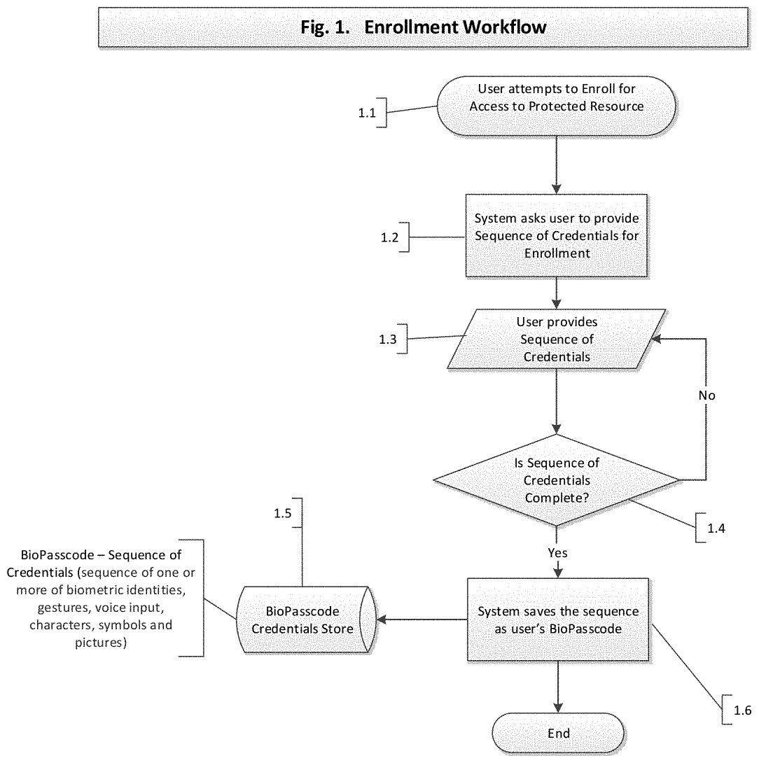

FIG. 1. Enrollment Workflow

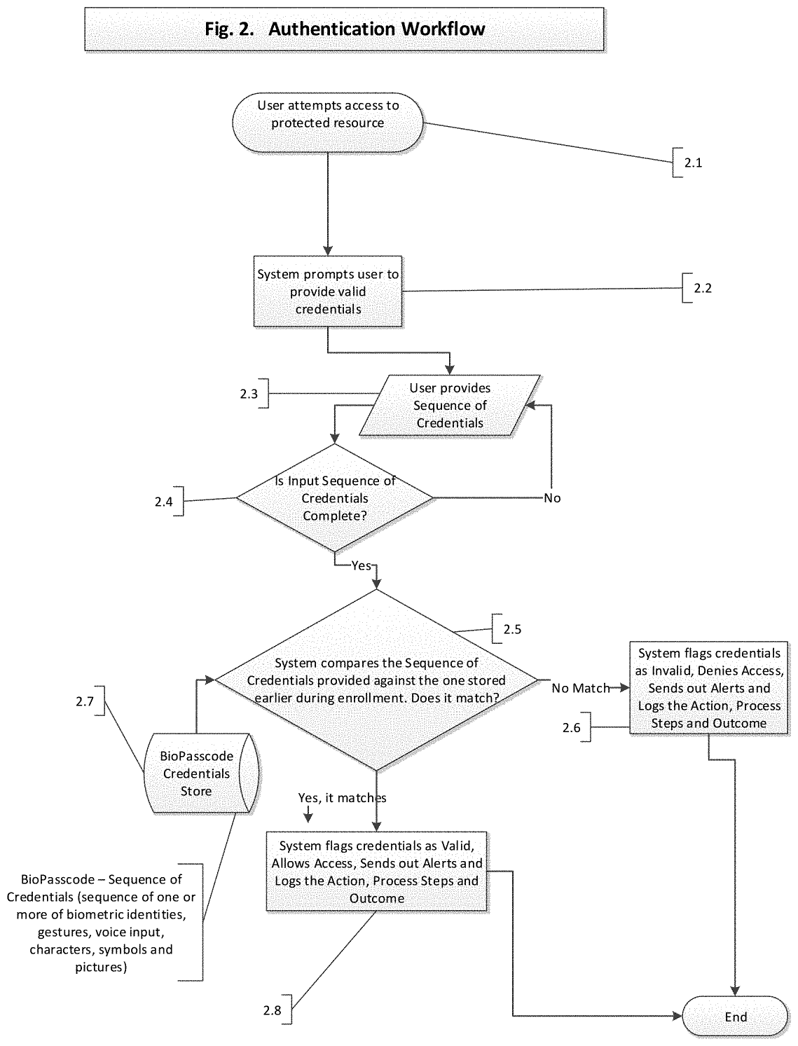

FIG. 2. Authentication Workflow

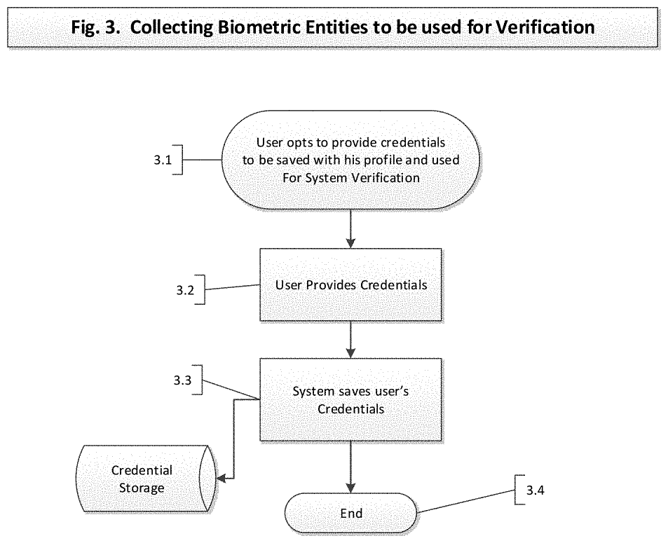

FIG. 3. Collecting Biometric Entities to be used for Verification Workflow

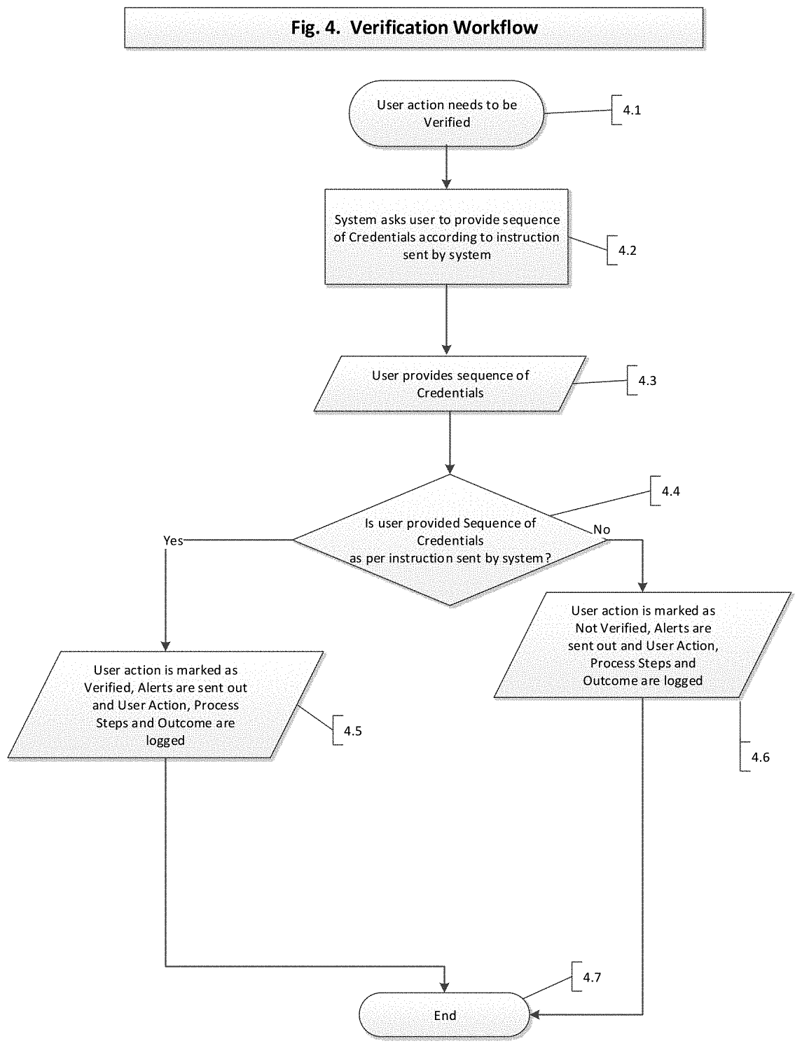

FIG. 4. Verification Workflow

### Examples of Biopasscode

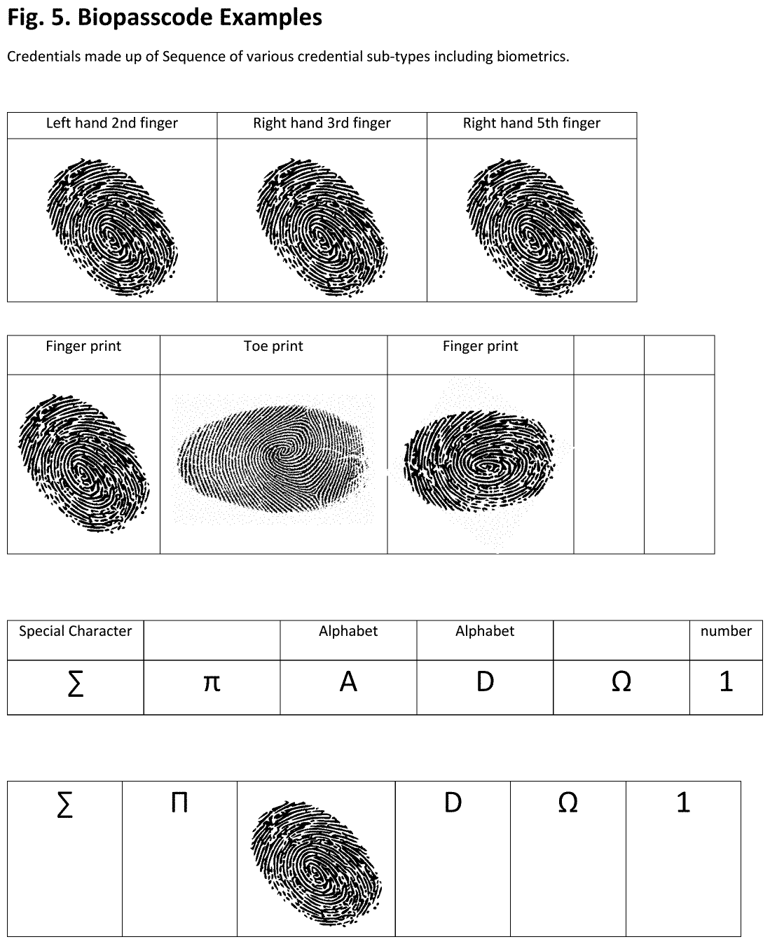

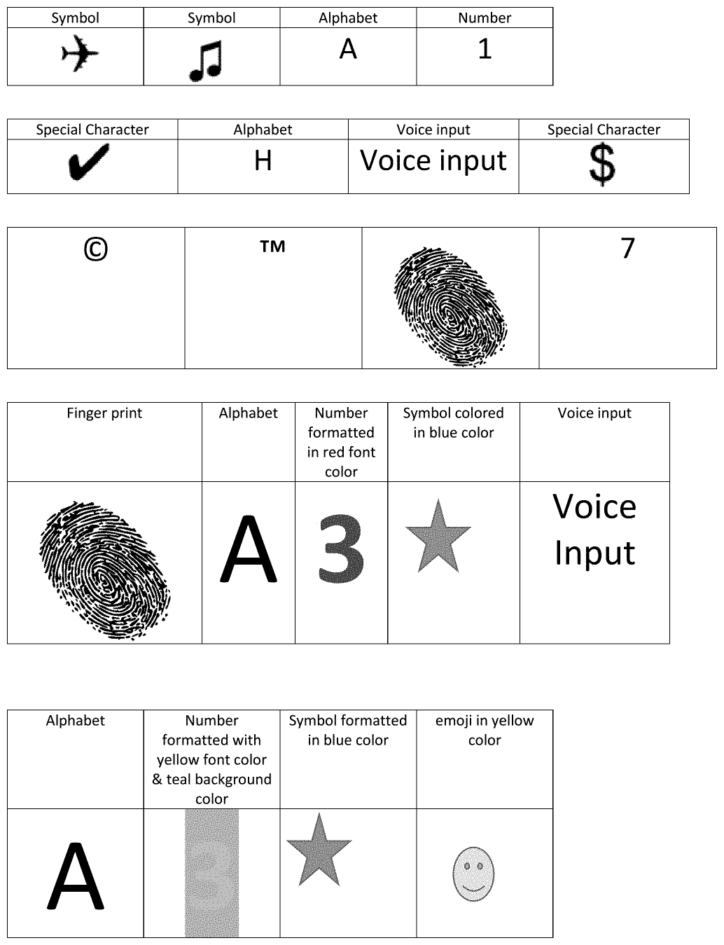

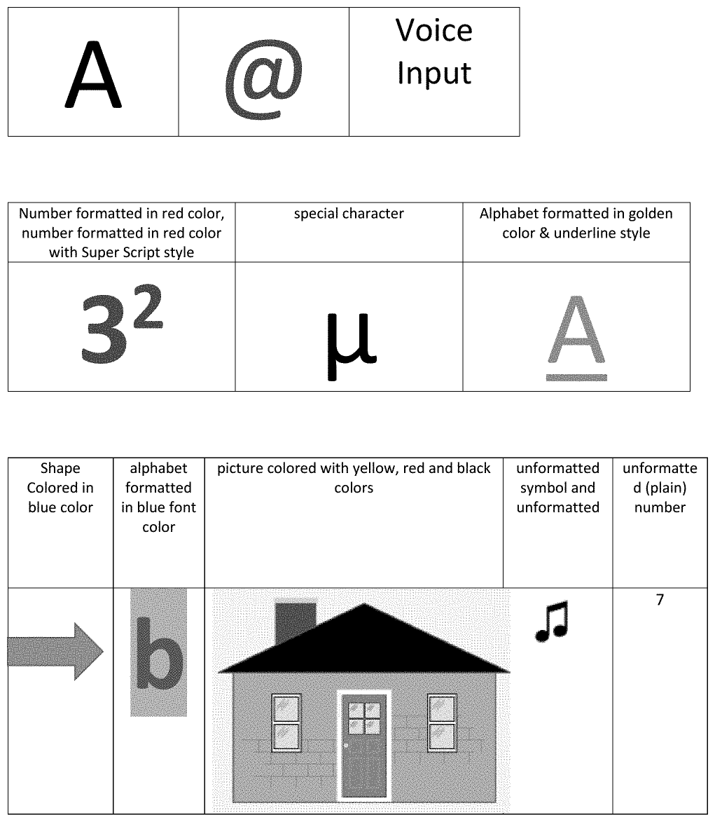

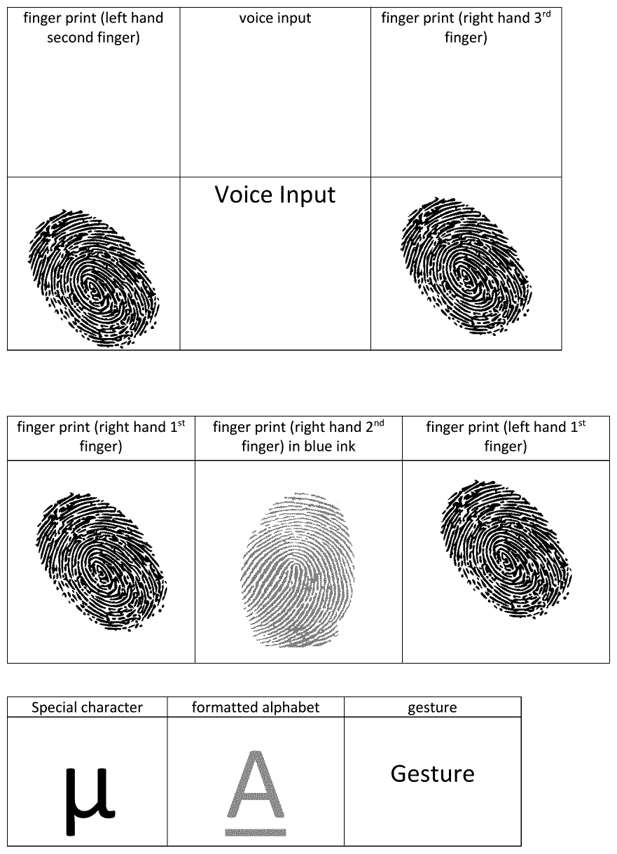

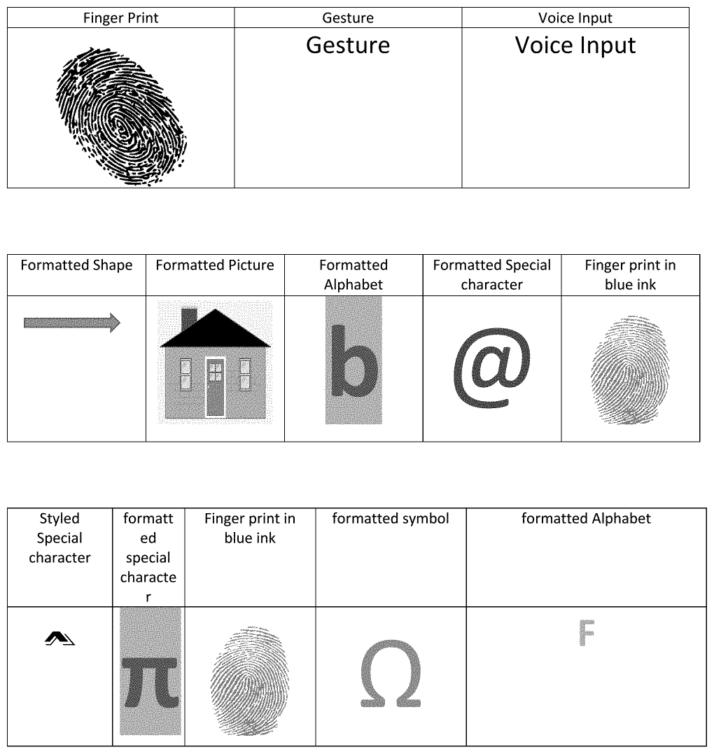

FIG. 5. Biopasscode Examples

1. A computer-implemented process of authenticating a user requesting access to protected entity using credentials that are personalized using sequence made up of one or more of user's biometric identities, gestures, voice input, plain characters, formatted characters, unformatted symbol, formatted symbol, unformatted picture and formatted picture, the process comprising:
using a computing device, sensors, cameras and biometric capturing devices to perform the steps of:
capturing sequence that includes one or more of user's biometric identities, gestures, voice input, plain characters, formatted characters, unformatted symbol, formatted symbol, unformatted picture and formatted picture from the user, wherein the biometric identities comprise one or more of user's finger prints, toe prints, knee scan, iris scan, palm vein and any other body feature or part's image or scan that uniquely identifies a person, formatted characters formatted using formatting options comprising Font, Font Size, Font Color, Shading, Font Style, Font Effects, Font Underline, and character effects, formatted symbol and picture formatted using formatting options comprising of applying picture effects, tinting, filtering, folding, cropping, coloring, cutting, zooming, styling, picture bordering, and framing;
comparing the captured credentials against credentials stored on a server that are designated by the user as valid credentials prior to requesting access;
flagging the captured credentials as valid and allowing the user to have access when the comparison indicates that a match occurs, flagging the captured credentials as invalid and rejecting the request for access when the comparison indicates that a match does not occur;
alerting the user via alert communication methods chosen by the user including email, text message, Smartphone Notifications, voice message, voice call, SMS, audible alarm, or visual clues; and
logging the user action, process steps and its outcome.

2. The process of claim 1, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

3. The process of claim 1, wherein the valid credentials are set for each time range and time range is of duration of minutes, a day, days, week, weeks, month, years, day of week or time period of the day.

4. An apparatus comprising:
one or more processors;
one or more biometric capturing devices;
a memory storing instructions that when executed by the one or more processors perform the steps comprising:
using a computing device and biometrics capturing devices to perform the steps of:
capturing sequence that includes one or more of user's biometric identities, gestures, voice input, plain characters, formatted characters, unformatted symbol, formatted symbol, unformatted picture and formatted picture from the user, wherein the biometric identities comprise one or more of user's finger prints, toe prints, knee scan, iris scan, palm vein and any other body feature or part's image or scan that uniquely identifies a person, formatted characters formatted using formatting options comprising Font, Font Size, Font Color, Shading, Font Style, Font Effects, Font Underline, and character effects, formatted symbol and picture formatted using formatting options comprising of applying picture effects, tinting, filtering, folding, cropping, coloring, cutting, zooming, styling, picture bordering, and framing;
comparing the captured credentials against credentials stored on a server that are designated by the user as valid credentials prior to requesting access;
flagging the captured credentials as valid and allowing the user to have access when the comparison indicates that a match occurs, flagging the captured credentials as invalid and rejecting the request for access when the comparison indicates that a match does not occur;
alerting the user via alert communication methods chosen by the user including email, text message, Smartphone Notifications, voice message, voice call, SMS, audible alarm, or visual clues; and
logging the user action, process steps and its outcome.

5. The apparatus of claim 4, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

6. A non-transitory computer-readable medium having instructions stored thereon executable by a computing platform to:
use a computing device and biometric capturing devices to perform the steps of:
capture sequence that includes one or more of user's biometric identities, gestures, voice input, plain characters, formatted characters, unformatted symbol, formatted symbol, unformatted picture and formatted picture from the user, wherein the biometric identities comprise one or more of user's finger prints, toe prints, knee scan, iris scan, palm vein and any other body feature or part's image or scan that uniquely identifies a person, formatted characters formatted using formatting options comprising Font, Font Size, Font Color, Shading, Font Style, Font Effects, Font Underline, and character effects, formatted symbol and picture formatted using formatting options comprising of applying picture effects, tinting, filtering, folding, cropping, coloring, cutting, zooming, styling, picture bordering, and framing;
compare the captured credentials against credentials stored on a server that are designated by the user as valid credentials prior to requesting access;
flag the captured credentials as valid and allowing the user to have access when the comparison indicates that a match occurs, flag the captured credentials as invalid and rejecting the request for access when the comparison indicates that a match does not occur;
alert the user via alert communication methods chosen by the user including email, text message, Smartphone Notifications, voice message, voice call, SMS, audible alarm, or visual clues; and
log the user action, process steps and its outcome.

7. The computer-readable medium of claim 6, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

8. A computer-implemented user authentication process that has an ability to be independently invoked for authenticating a user request to access a protected resource or to supplement authenticating a user requesting access to the protected resource, the process comprising:
using a computing device and biometric capturing devices to perform the steps of: delivering sequencing instructions, which instruct the user, how to sequence given list comprising of one or more of user's biometric identities, characters, symbols and pictures, to the user over an alternate channel including Email, SMS, Smartphone Notification, voice message, picture message, video message, or hardware device given to user or accessible to user to receive instructions remotely;
capturing sequence that includes one or more of user's biometric identities, gestures, voice input, plain characters, formatted characters, unformatted symbol, formatted symbol, unformatted picture and formatted picture from the user, wherein the biometric identities comprise one or more of user's finger prints, toe prints, knee scan, iris scan, palm vein and any other body feature or part's image or scan that uniquely identifies a person, formatted characters formatted using formatting options comprising Font, Font Size, Font Color, Shading, Font Style, Font Effects, Font Underline, and character effects, formatted symbol and picture formatted using formatting options comprising of applying picture effects, tinting, filtering, folding, cropping, coloring, cutting, zooming, styling, picture bordering, and framing;
comparing the captured sequence of identities against a stored sequence of identities on a server that is generated using same instructions sent to the user using the alternate channel;
flagging the captured sequence of identities as correct and alternate authentication process as success when the comparison indicates that a match occurs, flagging the captured sequence of identities as incorrect and alternate authentication process as failure when the comparison indicates that a match does not occur;
alerting the user via alert communication methods chosen by the user including email, text message, Smartphone Notifications, voice message, voice call, SMS, audible alarm, or visual clues; and
logging the user action, process steps and its outcome.

9. The process of claim 8, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

10. An apparatus comprising:
one or more processors;
one or more biometric capturing devices;
a memory storing instructions that when executed by the one or more processors perform the steps comprising:
using a computing device and biometrics capturing devices to perform the steps of:
delivering sequencing instructions, which instruct the user, how to sequence given list comprising of one or more of user's biometric identities, characters, symbols and pictures, to the user over an alternate channel including Email, SMS, Smartphone Notification, voice message, picture message, video message, or hardware device given to user or accessible to user to receive instructions remotely;
capturing sequence that includes one or more of user's biometric identities, gestures, voice input, plain characters, formatted characters, unformatted symbol, formatted symbol, unformatted picture and formatted picture from the user, wherein the biometric identities comprise one or more of user's finger prints, toe prints, knee scan, iris scan, palm vein and any other body feature or part's image or scan that uniquely identifies a person, formatted characters formatted using formatting options comprising Font, Font Size, Font Color, Shading, Font Style, Font Effects, Font Underline, and character effects, formatted symbol and picture formatted using formatting options comprising of applying picture effects, tinting, filtering, folding, cropping, coloring, cutting, zooming, styling, picture bordering, and framing;
comparing the captured sequence of identities against a stored sequence of identities on a server that is generated using same instructions sent to the user using the alternate channel;
flagging the captured sequence of identities as correct and alternate authentication process as success when the comparison indicates that a match occurs, flagging the captured sequence of identities as incorrect and alternate authentication process as failure when the comparison indicates that a match does not occur;
alerting the user via alert communication methods chosen by the user including email, text message, Smartphone Notifications, voice message, voice call, SMS, audible alarm, or visual clues; and
logging the user action, process steps and its outcome.

11. The apparatus of claim 10, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

12. A non-transitory computer-readable medium having instructions stored thereon executable by a computing platform to:
use a computing device and biometric capturing devices to perform the steps of:
delivering sequencing instructions, which instruct the user, how to sequence given list comprising of one or more of user's biometric identities, characters, symbols and pictures, to the user over an alternate channel including Email, SMS, Smartphone Notification, voice message, picture message, video message, or hardware device given to user or accessible to user to receive instructions remotely;
capturing sequence that includes one or more of user's biometric identities, gestures, voice input, plain characters, formatted characters, unformatted symbol, formatted symbol, unformatted picture and formatted picture from the user, wherein the biometric identities comprise one or more of user's finger prints, toe prints, knee scan, iris scan, palm vein and any other body feature or part's image or scan that uniquely identifies a person, formatted characters formatted using formatting options comprising Font, Font Size, Font Color, Shading, Font Style, Font Effects, Font Underline, and character effects, formatted symbol and picture formatted using formatting options comprising of applying picture effects, tinting, filtering, folding, cropping, coloring, cutting, zooming, styling, picture bordering, and framing;
compare the captured sequence of identities against a stored sequence of identities on a server that is generated using same instructions sent to the user using the alternate channel;
flag the captured sequence of identities as correct and alternate authentication process as success when the comparison indicates that a match occurs, flag the captured sequence of identities as incorrect and alternate authentication process as failure when the comparison indicates that a match does not occur;
alert the user via alert communication methods chosen by the user including email, text message, Smartphone Notifications, voice message, voice call, SMS, audible alarm, or visual clues; and
log the user action, process steps and its outcome.

13. The computer-readable medium of claim 12, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.
